(19) United States
(12) Patent Application Publication
(10) Pub. No.: US 2011/0175481 A1
(43) Pub. Date: Jul. 21, 2011

(54) PERMANENT TYPE ROTARY MACHINE

(75) Inventor: Kouji Kebukawa, Nagano (JP)

(73) Assignee: SHINANO KENSHI KABUSHIKI KAISHA, Ueda-shi (JP)

(21) Appl. No.: 12/977,856

(22) Filed: Dec. 23, 2010

(30) Foreign Application Priority Data
Jan. 20, 2010 (JP) 2010-009570

(51) Int. Cl. H02K 21/14; H02K 1/06

(52) U.S. Cl. 310/156.45; 310/198

(57) ABSTRACT

The permanent magnet type rotary machine is capable of reducing cogging torque even if permanent magnets are displaced in the axial direction and which is capable of reducing production cost and increasing torque. At least a stator unit of a first phase out of two stator units, which are stacked with a phase difference of (360°/(2P)), is stacked m-th, from one end of the stack of the stator units, to face magnetic poles of one of the permanent magnets. The other stator unit of the second phase, whose excitation cycle is shifted ¼ cycle with respect to that of the stator unit of the first phase, is stacked ((nQ/2)+m)-th, from the one end of the stack, to face magnetic poles of another permanent magnet. Note that, P is number of the magnetic poles of the permanent magnet; m is an integer of (nQ/2) or less, and one or more; Q is an even number of two or more; and n is an integer of one or more, and the product of n×Q is an integer of four or more.

### CROSS-REFERENCE TO RELATED APPLICATION

This application is based upon and claims the benefit of priority of the prior Japanese Patent Application No. P2010-009570, filed on Jan. 20, 2010, and the entire contents of which are incorporated herein by reference.

### FIELD

The present invention relates to a permanent magnet type rotary machine, e.g., multi-phase stepping motors incorporated in office automation equipment—such as copiers and printers, peripheral units of computers, vehicles, factory automation equipment—such as conveyors.

### BACKGROUND

Various types of multi-phase stepping motors are known. For example, a PM type stepping motor has a permanent magnetic rotor; a VR type stepping motor has a rotor including a gear-shaped iron core; and a hybrid (HB) type stepping motor has a rotor including a permanent magnet and a gear-shaped iron core. Further, the stepping motors are classified into an inner rotor type and an outer rotor type. In the PM type multi-phase stepping motor, the rotor includes a permanent magnet, in which N-poles and S-poles are alternately formed to face stator units stacked in the axial direction. By energizing coils in the stator units with changing current direction, stator magnetic poles and rotor magnetic poles attract and repulse each other, so that the rotor can be rotated.

In a typical permanent magnet type rotary machine, a rotor is constituted by a shaft and a single permanent magnet attached to the shaft, and two stator units are stacked and faced each other. Number of stacking the stator units is equal to that of phases (see Japanese Laid-open Patent Publication No. P2000-4570A). These days, high efficiency motors have been required. Thus, permanent magnets composed of rare-earth metals, e.g., Nd—Fe—B, whose maximum energy products are great, are employed so as to generate great torque with small input energy. However, in the rotary machine having such permanent magnet, magnetic flux is easily saturated in base parts of magnetic pole teeth (claw poles), so sufficient torque cannot be generated.

These days, a permanent magnet type rotary machine whose stator includes four or more stator units has been a focus of attention. In the rotary machine, magnetic flux is hardly saturated in base parts of claw poles of stator yokes, great torque can be generated, a thickness of each stator unit can be reduced, a production cost of the rotary machine can be reduced, and processing accuracy can be improved.

However, if a permanent magnet is displaced, in the axial direction, with respect to stator units when a user attaches a multi-phase stepping motor, balance of the stator units stacked to cancel cogging torque, with respect to an axial length of the permanent magnet or a facing area of the permanent magnet facing claw poles, will be lost. By losing the balance, cogging torque of a rotor will be varied, and vibration and noise of the motor will be increased.

Further, in case of employing a rare-earth magnet, whose maximum energy product is great, so as to realize a high efficiency motor, unbalance of magnetic flux variation must be great even if the permanent magnet is minutely shifted with respect to the stator units. Therefore, the problems of vibration and noise will significantly occur.

Thus, a washer having a U-shaped section and a spring washer, or a leaf spring is provided between a bearing of a shaft and a rotor so as to apply precompression to the rotor, but number of parts and production cost must be increased. Further, elements for reducing motor torque, e.g., increase of friction load, must be increased. By deterioration of the spring, the position of the rotor varies with the lapse of time, so cogging torque is also increased with the lapse of time.

### SUMMARY

Accordingly, it is an object in one aspect of the invention to provide a permanent magnet type rotary machine, which is capable of reducing cogging torque even if permanent magnets are displaced in the axial direction and which is capable of reducing production cost and increasing torque.

To achieve the object, the permanent magnet type rotary machine of the present invention is driven by Q-phase (Q is an even number of two or more) excitation drive system, and the rotary machine comprises:
a multiple-phase excitation stator including a plurality of stacked stator units, in each of which air-core coils are sandwiched between stator yokes and magnetic pole teeth of the stator yokes are mutually geared, all of the stator units having the same number of magnetic pole teeth which are spaced, in the rotational direction of a rotor, at regular intervals, the stator units in the same phase being divided into n (n is an integer of one or more and the product of n and Q is an integer of four or more) for one phase and coaxially stacked; and
the rotor including a plurality of permanent magnets, which are arranged in the axial direction and whose magnetic poles face the magnetic pole teeth of the stator yokes,

at least the stator unit of the first phase out of the two stator units, which are stacked with a phase difference of (360°/(2P)) (P is number of the magnetic poles of the permanent magnet), is stacked m-th (m is an integer of (nQ/2) or less, and one or more), from one end of the stack of the stator units, to face the magnetic poles of one of the permanent magnets, and

the other stator unit of the second phase, whose excitation cycle is shifted ¼ cycle with respect to that of the stator unit of the first phase, is stacked ((nQ/2)+m)-th, from the one end of the stack, to face the magnetic poles of another permanent magnet.

Preferably, the permanent magnets are a first magnet and a second magnet, which are arranged in an axial direction of a shaft,

the first magnet faces the magnetic pole teeth of the stator units which are the first to (nQ/2)-th stator units from the one end of the stack, and

the second magnet faces the magnetic pole teeth of the stator units which are the ((nQ/2)+1)-th to nQ-th stator units from the one end of the stack.

Preferably, relationship between a distance T1, which is an axial distance from a plane perpendicular to the axis of the one end of the stack to the first magnet, and a distance T2, which is an axial distance from an intermediate plane perpendicular to the axis of the stack to the second magnet, is 0.6<T2/T1<1.6.

Preferably, the permanent magnets are a first magnet, a second magnet, a third magnet and a fourth magnet, which are arranged in an axial direction of a shaft,

the first and second magnets face the magnetic pole teeth of the stator units which are the first to (nQ/2)-th stator units from the one end of the stack, and

the third and fourth magnets face the magnetic pole teeth of the stator units which are the ((nQ/2)+1)-th to nQ-th stator units from the one end of the stack.

Preferably, relationship between a distance T1, which is an axial distance from a plane perpendicular to the axis of the one end of the stack to the first magnet, a distance T2, which is an axial distance from the plane perpendicular to the axis of the one end of the stack to the second magnet, a distance T3, which is an axial distance from an intermediate plane perpendicular to the axis of the stack to the third magnet, and a distance T4, which is an axial distance from the intermediate plane perpendicular to the axis of the stack to the fourth magnet, is 0.6<T3/T1<1.6 and 0.6<T4/T2<1.6.

Effects of the permanent magnet type rotary machine of the present invention will be explained. For example, in case that Q=2 (two-phase motor), m=1 and n=2, the first stator unit is divided into two, i.e., an A-phase and an A′-phase, and the second stator unit is divided into two, i.e., a B-phase and a B′-phase. The stator unit of the A-phase is the first stator unit from the one end of the stack of the stator units, and it faces the first magnet; and the stator unit of the B-phase is the third stator unit from the one end of the stack, and it faces the second magnet. The stator units have the phase structure of the A-phase—the A′-phase—the B-phase—the B′-phase. Note that, the A-phase and the B-phase are stacked with phase difference of (360°/(2P)) or electric angle of 90° (note that, P is number of magnetic poles of the permanent magnet), and the A′-phase and the B′-phase are stacked with the same phase difference. Excitation cycle of the B-phase is shifted ¼ cycle with respect to that of the A-phase, and excitation cycle of the B′-phase is shifted ¼ cycle with respect to that of the A′-phase.

By stacking the stator units as described above, cogging torque generated by magnetic circuits formed between the permanent magnets and the stator can be cancelled between the A-phase and the B-phase and between the A′-phase and the B′-phase, so that resultant cogging torque of the motor can be reduced.

In an embodiment, the permanent magnets are the first magnet and the second magnet, which are arranged in the axial direction of the shaft, the first magnet faces the first and second stator units from the one end of the stack, and the second magnet faces the third and fourth stator units from the one end of the stack. Even if the rotor is displaced, with respect to the stator, in the axial direction, cogging torque can be cancelled between the A-phase and the B-phase, which are shifted with the phase angle of (360°/(2P)), and between the A′-phase and the B′-phase, which are shifted with the same phase angle.

In an embodiment, the relationship between the distance T1, which is the axial distance from the plane perpendicular to the axis of the one end of the stack to the first magnet, and the distance T2, which is the axial distance from the intermediate plane perpendicular to the axis of the stack to the second magnet, is 0.6<T2/T1<1.6.

Even if the position of the rotor is displaced in the axial direction, amount of increasing or reducing a total facing area of the permanent magnets facing the magnetic pole teeth of the stator is not varied in the axial direction due to a gap between the first magnet and the second magnet, so that unbalance of amount of magnetic flux can be small and cogging torque can be reduced.

In an embodiment, the permanent magnets are the first magnet, the second magnet, the third magnet and the fourth magnet, which are arranged in the axial direction of the shaft, the first and second magnets face the first and second stator units from the one end of the stack, and the third and fourth magnets face the third and fourth stator units from the one end of the stack. With this structure, even if the rotor is displaced, with respect to the stator, in the axial direction, cogging torque can be cancelled between the A-phase and the B-phase, which are shifted with the phase angle of (360°/(2P)), and between the A′-phase and the B′-phase, which are shifted with the same phase angle.

Even if the position of the rotor is displaced in the axial direction, amount of increasing or reducing a total facing area of the permanent magnets facing the magnetic pole teeth of the stator is not varied in the axial direction due to gaps between the first to fourth magnets, so that unbalance of amount of magnetic flux can be small and cogging torque can be reduced.

### BRIEF DESCRIPTION OF THE DRAWINGS

Embodiments of the present invention will now be described by way of examples and with reference to the accompanying drawings, in which:

FIG. 1 shows a perspective view of a rotor and a sectional view of a stator;

FIG. 2 shows perspective views of the rotor and the stator;

FIG. 3 is an explanation view of a stacking structure of the stator and the rotor of a first embodiment;

FIGS. 4A and 4B are graphs showing cogging torque generated in each of stator units shown in FIG. 3 and resultant cogging torque thereof;

FIG. 5 is an explanation view, wherein the rotor shown in FIG. 3 is displaced in the axial direction;

FIGS. 6A and 6B are graphs showing cogging torque generated in each of stator units shown in FIG. 5 and resultant cogging torque thereof;

FIG. 7 is an explanation view of a stacking structure of the stator and the rotor of a comparative example to the embodiment shown in FIG. 3;

FIGS. 8A and 8B are graphs showing cogging torque generated in each of stator units shown in FIG. 7 and resultant cogging torque thereof;

FIG. 9 is an explanation view, wherein the rotor shown in FIG. 7 is displaced in the axial direction;

FIGS. 10A and 10B are graphs showing cogging torque generated in each of stator units shown in FIG. 9 and resultant cogging torque thereof;

FIG. 11 is an explanation view of a stacking structure of the stator and the rotor of another comparative example to the embodiment shown in FIG. 3;

FIGS. 12A and 12B are graphs showing cogging torque generated in each of stator units shown in FIG. 11 and resultant cogging torque thereof;

FIG. 13 is an explanation view, wherein the rotor shown in FIG. 11 is displaced in the axial direction;

FIGS. 14A and 14B are graphs showing cogging torque generated in each of stator units shown in FIG. 13 and resultant cogging torque thereof;

FIG. 15 is an explanation view of a stacking structure of the stator and the rotor of a second embodiment;

FIGS. 16A and 16B are graphs showing cogging torque generated in each of stator units shown in FIG. 15 and resultant cogging torque thereof;

FIG. 17 is an explanation view, wherein the rotor shown in FIG. 15 is displaced in the axial direction;

FIGS. 18A and 18B are graphs showing cogging torque generated in each of stator units shown in FIG. 17 and resultant cogging torque thereof;

FIG. 19 is an explanation view of a stacking structure of the stator and the rotor of a comparative example to the first and second embodiments;

FIGS. 20A and 20B are graphs showing cogging torque generated in each of stator units shown in FIG. 19 and resultant cogging torque thereof;

FIG. 21 is an explanation view, wherein the rotor shown in FIG. 19 is displaced in the axial direction;

FIGS. 22A and 22B are graphs showing cogging torque generated in each of stator units shown in FIG. 21 and resultant cogging torque thereof; and

FIG. 23 is a graph showing relationship between a distance from one end of stacked stator units to a permanent magnet and cogging torque.

### DETAILED DESCRIPTION OF THE EMBODIMENTS

Preferred embodiments of the present invention will now be described in detail with reference to the accompanying drawings. In the following description, multi-phase stepping motors are explained as preferred embodiments of the present invention. The stepping motors can be incorporated in, for example, office automation equipment, peripheral units of computers, vehicles, and factory automation equipment—such as conveyors. In the following embodiments, the stepping motors are inner rotor type stepping motors.

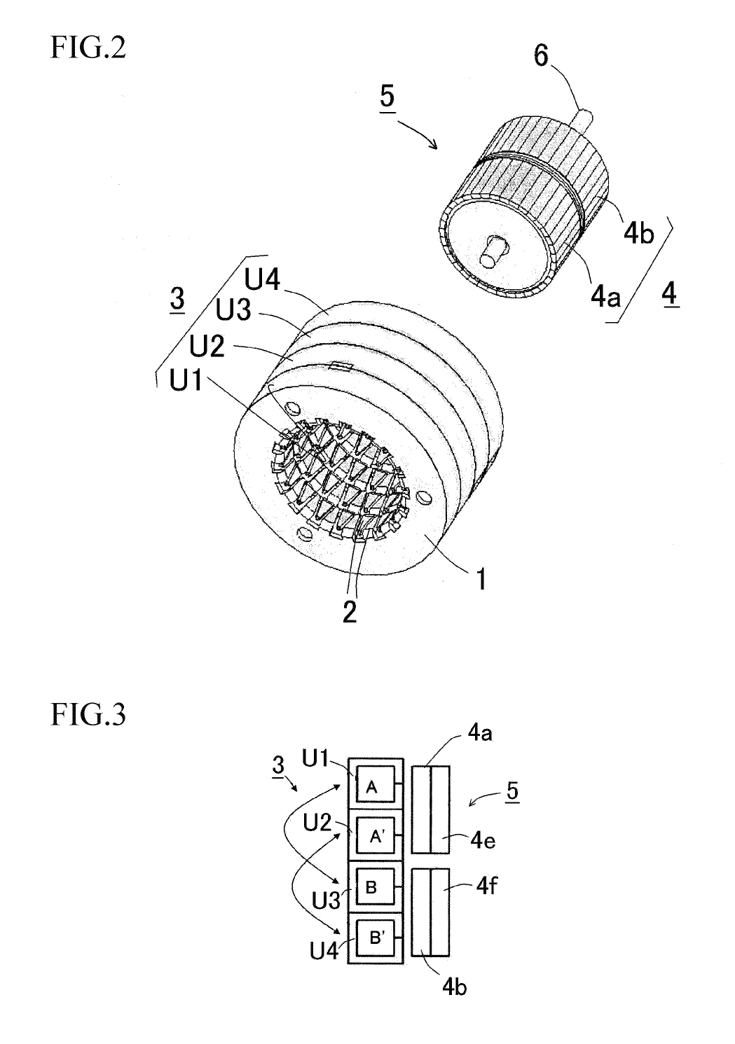

In the embodiment shown in FIG. 2, number of phases Q of the multi-phase stepping motor is two (Q=2). The stepping motor comprises: a multiple-phase excitation stator 3 including a plurality of stacked stator units U1-U4, in each of which air-core coils (not shown) are sandwiched between stator yokes 1 and magnetic pole teeth (claw poles) 2 of the stator yokes 1 are mutually geared, the stator units in the same phase, which have the same excitation cycle, being divided into n (n is an integer of one or more and the product of n×Q is an integer of four or more, n=2 in the embodiments) for one phase and coaxially stacked; and a rotor 5 including a plurality of permanent magnets whose magnetic poles face the claw poles 2 of the stator yokes 1.

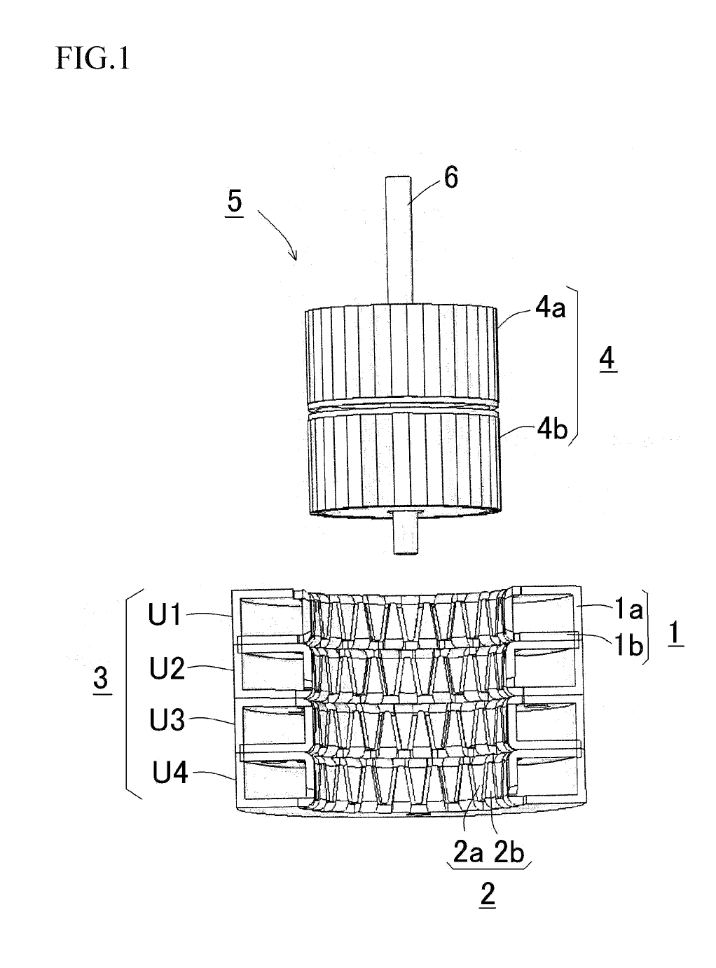

A schematic structure of the multi-phase stepping motor will be explained with reference to FIG. 1. The rotor 5 is constituted by a permanent magnet 4, in which N-poles and S-poles are alternately formed in the circumferential direction, and a rotary shaft 6, with which the permanent magnet 4 is integrated. The permanent magnet 4 is constituted by a first magnet 4a and a second magnet 4b, which are arranged in the axial direction of the shaft 6. The first and second magnets 4a and 4b face the claw poles 2 of the stator 3.

In the stator 3 shown in FIG. 1, each pair of stator yokes 1a and 1b vertically sandwich the air-core coils (not shown), in each of which a wire is wound on a bobbin, and comb-shaped claw poles 2a and 2b are mutually geared. The stator 3 is accommodated in a housing (not shown), and the shaft 6 is rotatably held by a bearing section.

In the stator 3 shown in FIG. 1, the stator units U1 and U2 in the same phase, which have the same excitation cycle, are divided into n (n=2 in FIG. 1) for one phase and coaxially stacked, and the stator units U3 and U4 in the same phase, which have the same excitation cycle, are divided into n (n=2 in FIG. 1) for one phase and coaxially stacked.

### First Embodiment

In FIG. 3, the stator 3 is driven by two-phase (Q=2) excitation drive system, in which the stator units U1 and U2 correspond to an A-phase and an A′-phase and the stator units U3 and U4 correspond to a B-phase and a B′-phase. The A-phase and the B-phase are stacked with a phase difference of (360°/(2P)) (P is number of the magnetic poles of the permanent magnet 4), and the A′-phase and the B′-phase are stacked with the same phase difference. The stator unit U1 of the A-phase is located m-th (m is an integer of (nQ/2) or less, and one or more, m=1 in the present embodiment) from one end (an upper end in the present embodiment) of the stack of the stator units U1-U4; the stator unit U3 of the B-phase is located (m+(nQ/2))-th (m=3 in the present embodiment) from the one end of the stack.

In the stator 3, the stator units are stacked as the A-phase—the A′-phase—the B-phase—the B′-phase. The A-phase and the B-phase are stacked with a phase difference of (360°/(2P)), i.e., an electric angle of 90° (P is number of the magnetic poles of the permanent magnet 4), and the A′-phase and the B′-phase are stacked with the same phase difference. The A-phase and the A′-phase in the same phase are stacked with a phase difference of (360°/(4P)), i.e., an electric angle of 45°, and the B′-phase and the B′-phase in the same phase are stacked with the same phase difference. Note that, excitation cycle of the B-phase is shifted ¼ cycle with respect to that of the A-phase, and excitation cycle of the B′-phase is shifted ¼ cycle with respect to that of the A′-phase.

The permanent magnet 4 is constituted by the first magnet 4a and the second magnet 4b, which are arranged in the axial direction of the shaft 6 and integrated with the shaft 6 by back yokes 4e and 4f.

The first magnet 4a faces the first stator unit U1 and the second ((nQ/2)=2) stator unit U2 from the upper end of the stack; the second magnet 4b faces the third ((nQ/2)+1=3) stator unit U3 and the fourth (nQ=4) stator unit U4 from the upper end of the stack. A distance T1, which is an axial distance from a plane perpendicular to the axis of the upper end of the stack (i.e., an upper end face of the stator unit U1) to the first magnet 4a, is equal to a distance T2, which is an axial distance from an intermediate plane perpendicular to the axis of the stack (i.e., a boundary plane between the stator unit U2 and the stator unit U3) to the second magnet 4b.

Note that, T1=T2 is ideal, but the distances may be different within a nonproblematic range for motor operations. The distances will be explained with reference to FIG. 23.

FIG. 23 is a graph showing relationship between T2/T1 (horizontal axis) and cogging torque (vertical axis) which is generated in the stepping motor having the stator 3 and the permanent magnet 4 shown in FIG. 3. When T2/T1=1, T1=T2; when T2/T1<1, T1>T2. When T2/T1=1 (T1=T2), the cogging torque is minimized. Experiences show that the motor can be operated with no problems, even if cogging torque is increased about 20% from the minimum value. When T2/T1=0.6 or 1.6, the cogging torque is increased 20%. Therefore, cogging torque can be suitably restrained as far as 0.6<T2/T1<1.6.

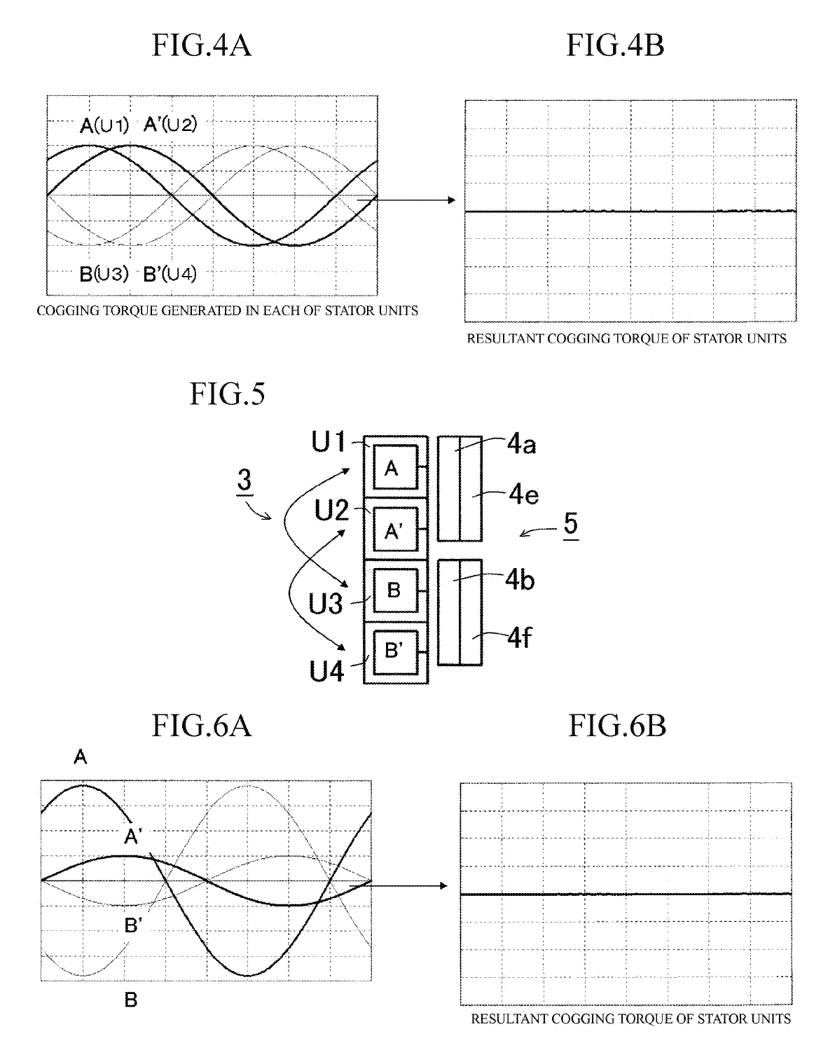

Cogging torque generated between the stator unit U1 of the A-phase, the stator unit U2 of the A′-phase and the first magnet 4a and cogging torque generated between the stator unit U3 of the B-phase, the stator unit U4 of the B′-phase and the second magnet 4b are shown in FIG. 4A. Resultant cogging torque of the cogging torque shown in FIG. 4A is shown in FIG. 4B. Since cogging torque is cancelled between the stator unit U1 of the A-phase and the stator unit U3 of the B-phase and between the stator unit U2 of the A′-phase and the stator unit U4 of the B′-phase, resultant cogging torque of the stator 3 can be reduced.

In FIG. 5, the rotor 5 is displaced in the axial direction. The rotor 5 is displaced, toward the stator unit U1 of the A-phase, from the state shown in FIG. 3. A facing area between the stator unit U1 of the A-phase and the first magnet 4a and a facing area between the stator unit U3 of the B-phase and the second magnet 4b are increased; a facing area between the stator unit U2 of the A′-phase and the first magnet 4a and a facing area between the stator unit U4 of the B′-phase and the second magnet 4b are reduced.

Cogging torque generated between the stator unit U1 of the A-phase, the stator unit U2 of the A′-phase and the first magnet 4a and cogging torque generated between the stator unit U3 of the B-phase, the stator unit U4 of the B′-phase and the second magnet 4b are shown in FIG. 6A. Resultant cogging torque of the cogging torque shown in FIG. 6A is shown in FIG. 6B. Since cogging torque is cancelled between the stator unit U1 of the A-phase and the stator unit U3 of the B-phase and between the stator unit U2 of the A′-phase and the stator unit U4 of the B′-phase, resultant cogging torque of the stator 3 can be reduced.

Therefore, even if the position of the rotor 5 is displaced, in the axial direction, by assembly error, amount of increasing or reducing the facing area of the permanent magnet 4 facing the claw poles of the stator 3 is not varied in the axial direction due to a gap between the first magnet 4a and the second magnet 4b, so that amount of varying magnetic flux can be small and cogging torque can be reduced.

### COMPARATIVE EXAMPLE 1

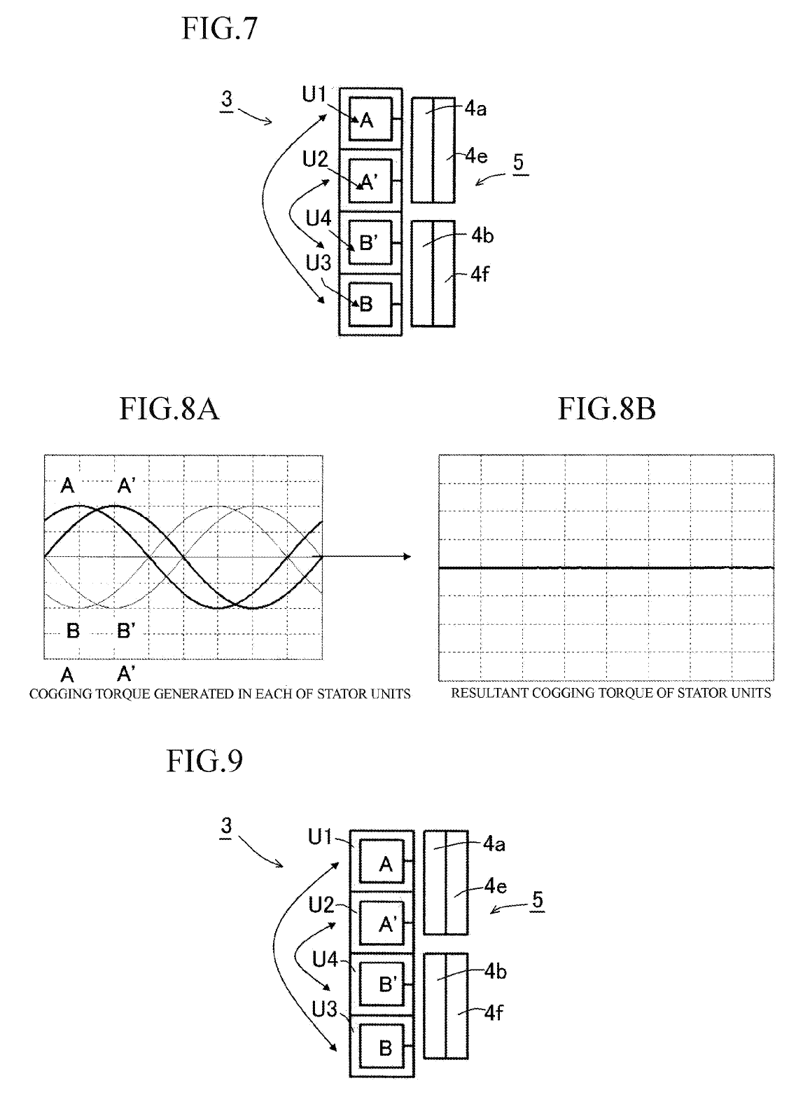

Next, a comparative example to the stator shown in FIG. 3 will be explained with reference to FIGS. 7-10B. Note that, the structure of the rotor 5 is the same as that shown in FIG. 3, so explanation will be omitted.

The stator 3 is driven by two-phase excitation drive system, and one phase is constituted by two units as well as the first embodiment. A stacking structure of the stator unit of the present comparative example is different from that of the first embodiment.

In the stator 3 shown in FIG. 7, the stator unit U1 of the A-phase, the stator unit U2 of the A′-phase, the stator unit U4 of the B′-phase and the stator unit U3 of the B-phase are stacked, in this order, from the upper end of the stack. The A-phase and the A′-phase are symmetrically formed with respect to an axial intermediate plane therebetween, and the B′-phase and the B-phase are symmetrically formed with respect to an axial intermediate plane therebetween as well.

The A-phase and the B-phase are stacked with phase difference of (360°/(2P)), i.e., electric angle of 90° (P is number of the magnetic poles of the permanent magnet 4), and the A′-phase and the B′-phase are stacked with the same phase difference. The A-phase and the A′-phase in the same phase are stacked with phase difference of (360°/(4P)), i.e., electric angle of 45°, and the B′-phase and the B′-phase in the same phase are stacked with the same phase difference as well as the first embodiment. Note that, excitation cycle of the B-phase is shifted ¼ cycle with respect to that of the A-phase, and excitation cycle of the B′-phase is shifted ¼ cycle with respect to that of the A′-phase as well as the first embodiment.

Cogging torque generated between the stator unit U1 of the A-phase, the stator unit U2 of the A′-phase and the first magnet 4a and cogging torque generated between the stator unit U4 of the B′-phase, the stator unit U3 of the B-phase and the second magnet 4b are shown in FIG. 8A. Resultant cogging torque of the cogging torque shown in FIG. 8A is shown in FIG. 8B. Since cogging torque is cancelled between the stator unit U1 of the A-phase and the stator unit U3 of the B-phase and between the stator unit U2 of the A′-phase and the stator unit U4 of the B′-phase, resultant cogging torque of the stator 3 can be reduced.

In FIG. 9, the rotor 5 is displaced in the axial direction. The rotor 5 is displaced, toward the stator unit U1 of the A-phase, from the state shown in FIG. 7. A facing area between the stator unit U1 of the A-phase and the first magnet 4a and a facing area between the stator unit U4 of the B′-phase and the second magnet 4b are increased; a facing area between the stator unit U2 of the A′-phase and the first magnet 4a and a facing area between the stator unit U3 of the B-phase and the second magnet 4b are reduced.

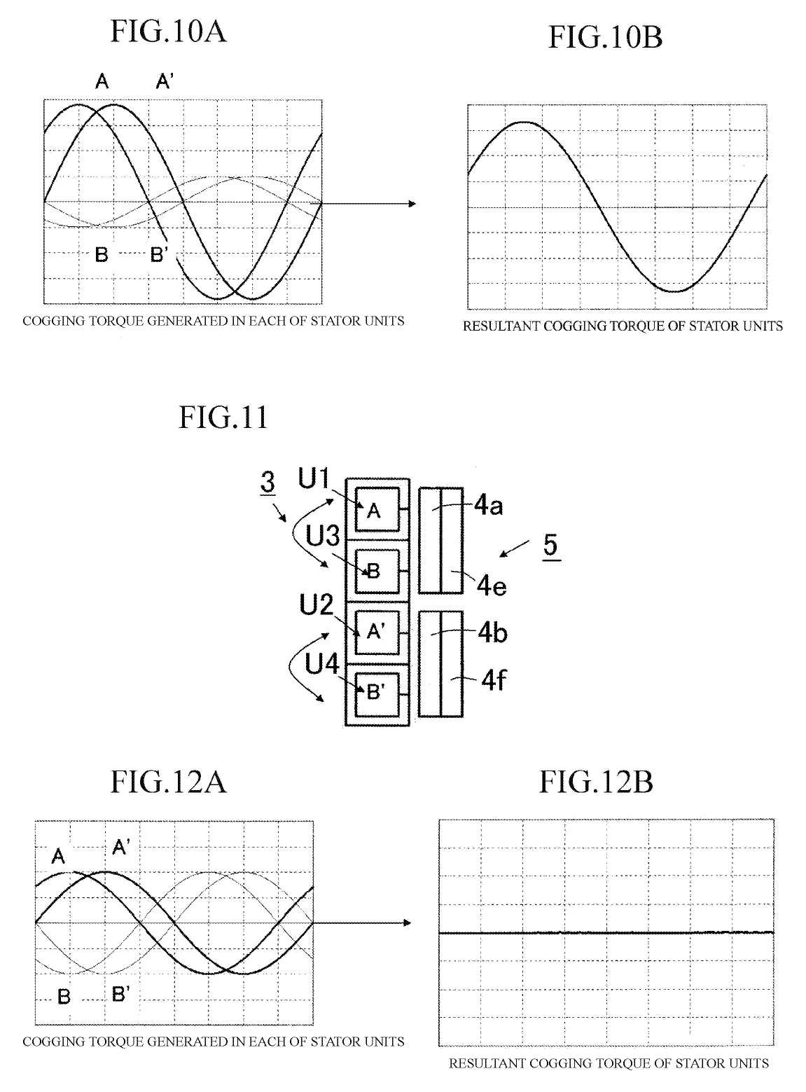

Cogging torque generated between the stator unit U1 of the A-phase, the stator unit U2 of the A′-phase and the first magnet 4a and cogging torque generated between the stator unit U4 of the B′-phase, the stator unit U3 of the B-phase and the second magnet 4b are shown in FIG. 10A. Resultant cogging torque of the cogging torque shown in FIG. 10A is shown in FIG. 10B. Since cogging torque is not cancelled between the stator unit U1 of the A-phase and the stator unit U3 of the B-phase and between the stator unit U2 of the A′-phase and the stator unit U4 of the B′-phase, so each cogging torque is left and resultant cogging torque of the stator 3 is generated.

### COMPARATIVE EXAMPLE 2

Next, another comparative example to the stator shown in FIG. 3 will be explained with reference to FIGS. 11-14B. Note that, the structure of the rotor 5 is the same as that shown in FIG. 3, so explanation will be omitted.

The stator 3 is driven by two-phase excitation drive system, and one phase is constituted by two units as well as the first embodiment. A stacking structure of the stator unit of the present comparative example is different from that of the first embodiment.

In the stator 3 shown in FIG. 11, the stator unit U1 of the A-phase, the stator unit U3 of the B-phase, the stator unit U2 of the A′-phase and the stator unit U4 of the B′-phase are stacked, in this order, from the upper end of the stack. Namely, the units of the A-phase and the units of the B-phase are alternately stacked.

The A-phase and the B-phase are stacked with a phase difference of (360°/(2P)), i.e., electric angle of 90° (P is number of the magnetic poles of the permanent magnet 4), and the A′-phase and the B′-phase are stacked with the same phase difference. The A-phase and the A′-phase in the same phase are stacked with phase difference of (360°/(4P)), i.e., electric angle of 45°, and the B′-phase and the B′-phase in the same phase are stacked with the same phase difference as well as the first embodiment. Note that, excitation cycle of the B-phase is shifted ¼ cycle with respect to that of the A-phase, and excitation cycle of the B′-phase is shifted ¼ cycle with respect to that of the A′-phase as well as the first embodiment.

Cogging torque generated between the stator unit U1 of the A-phase, the stator unit U3 of the B-phase and the first magnet 4a and cogging torque generated between the stator unit U2 of the A′-phase, the stator unit U4 of the B′-phase and the second magnet 4b are shown in FIG. 12A. Resultant cogging torque of the cogging torque shown in FIG. 12A is shown in FIG. 12B. Since cogging torque is cancelled between the stator unit U1 of the A-phase and the stator unit U3 of the B-phase and between the stator unit U2 of the A′-phase and the stator unit U4 of the B′-phase, resultant cogging torque of the stator 3 can be reduced.

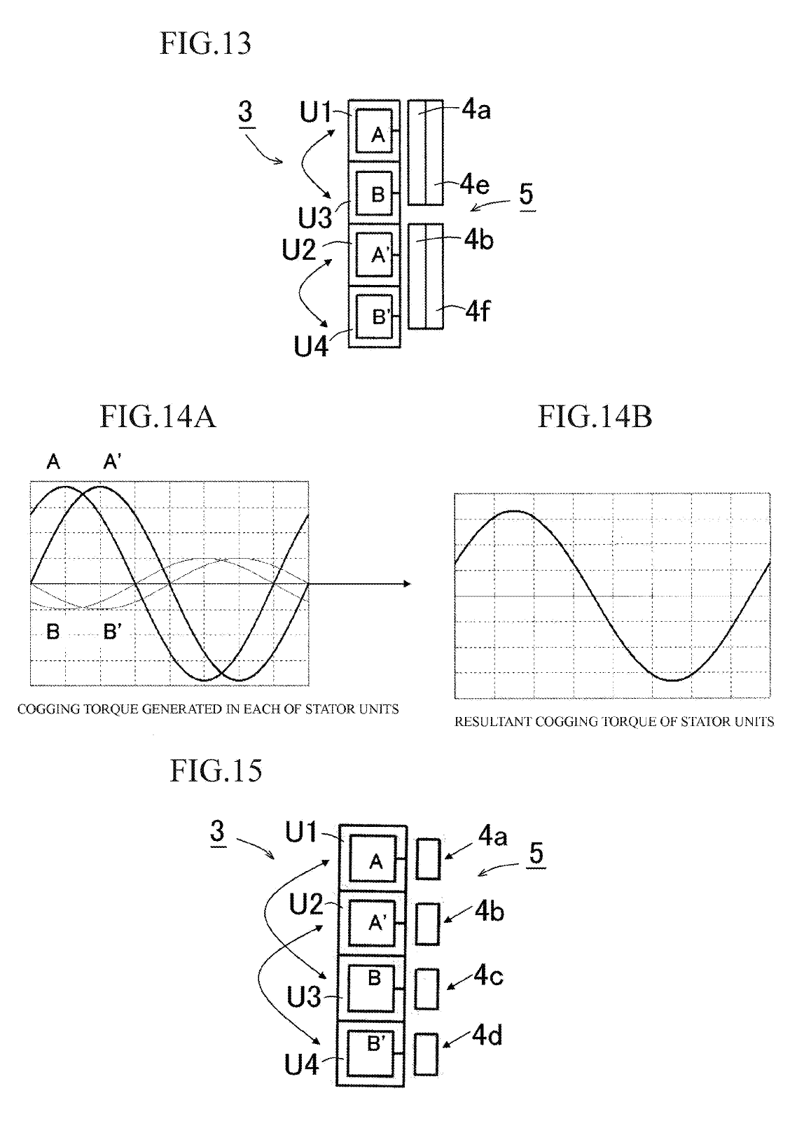

In FIG. 13, the rotor 5 is displaced in the axial direction. The rotor 5 is displaced, toward the stator unit U1 of the A-phase, from the state shown in FIG. 11. A facing area between the stator unit U1 of the A-phase and the first magnet 4a and a facing area between the stator unit U2 of the A′-phase and the second magnet 4b are increased; a facing area between the stator unit U3 of the B-phase and the first magnet 4a and a facing area between the stator unit U4 of the B′-phase and the second magnet 4b are reduced.

Cogging torque generated between the stator unit U1 of the A-phase, the stator unit U3 of the B-phase and the first magnet 4a and cogging torque generated between the stator unit U2 of the A′-phase, the stator unit U4 of the B′-phase and the second magnet 4b are shown in FIG. 14A. Resultant cogging torque of the cogging torque shown in FIG. 14A is shown in FIG. 14B. Since cogging torque is not cancelled between the stator unit U1 of the A-phase and the stator unit U3 of the B-phase and between the stator unit U2 of the A′-phase and the stator unit U4 of the B′-phase, so each cogging torque is left and resultant cogging torque of the stator 3 is generated.

By employing the stacking structure of the first embodiment and the rotor having two magnets, the stator unit U1 of the A-phase is stacked first (i.e., m=1; m is an integer of (nQ/2) or less, and one or more) from the one end of the stack, and the stator unit U3 of the B-phase is stacked third (i.e., (m+(nQ/2)=3) from the one end of the stack, so that cogging torque can be cancelled between the A-phase and the B-phase and between the A′-phase and the B′-phase even if the rotor 5 is displaced, with respect to the stator 3, in the axial direction.

### Second Embodiment

Next, a second embodiment of the permanent magnet type rotary machine will be explained with reference to FIGS. 15-18B. Note that, the structural elements shown in the first embodiment are assigned the same numeric symbols and explanation will be omitted. The stacking structure of the stator 3 is the same as that shown in FIG. 3, but the rotor 5 has a unique structure.

The permanent magnet 4 is constituted by a first magnet 4a, a second magnet 4b, a third magnet 4c and a fourth magnet 4d, which are arranged in the axial direction of the shaft 6 and integrated with the shaft 6. The first magnet 4a faces the first stator unit U1 of the A-phase from the upper end of the stack; the second magnet 4b faces the second stator unit U2 of the A′-phase; the third magnet 4c faces the third stator unit U3 of the B-phase; and the fourth magnet 4d faces the fourth stator unit U4 of the B′-phase.

As to the first to fourth magnets 4a-4d, a distance Ti, which is an axial distance from a plane perpendicular to the axis of the upper end of the stack (i.e., an upper end face of the stator unit U1) to the first magnet 4a, a distance T2, which is an axial distance from the perpendicular plane to the second magnet 4b, a distance T3, which is an axial distance from an intermediate plane perpendicular to the axis of the stack (i.e., a boundary plane between the second stator unit U2 and the third stator unit U3) to the third magnet 4c, and a distance T4, which is an axial distance from the intermediate plane to the fourth magnet 4d, are equal.

As described in the first embodiment with reference to FIG. 23, T1=T2=T3=T4 is ideal, but the distances may be different within a nonproblematic range for motor operations. The distances may be set under the conditions of 0.6<T3/T1<1.6 and 0.6<T4/T2<1.6.

The first to fourth magnets 4a-4d are attached to the shaft 6 by back yokes (not shown). The A-phase and the B-phase are stacked with phase difference of (360°/(2P)), i.e., electric angle of 90° (P is number of the magnetic poles of the permanent magnet 4), and the A′-phase and the B′-phase are stacked with the same phase difference. The A-phase and the A′-phase in the same phase are stacked with phase difference of (360°/(4P)), i.e., electric angle of 45°, and the B′-phase and the B′-phase in the same phase are stacked with the same phase difference as well as the first embodiment. Note that, excitation cycle of the B-phase is shifted ¼ cycle with respect to that of the A-phase, and excitation cycle of the B′-phase is shifted ¼ cycle with respect to that of the A′-phase as well as the first embodiment.

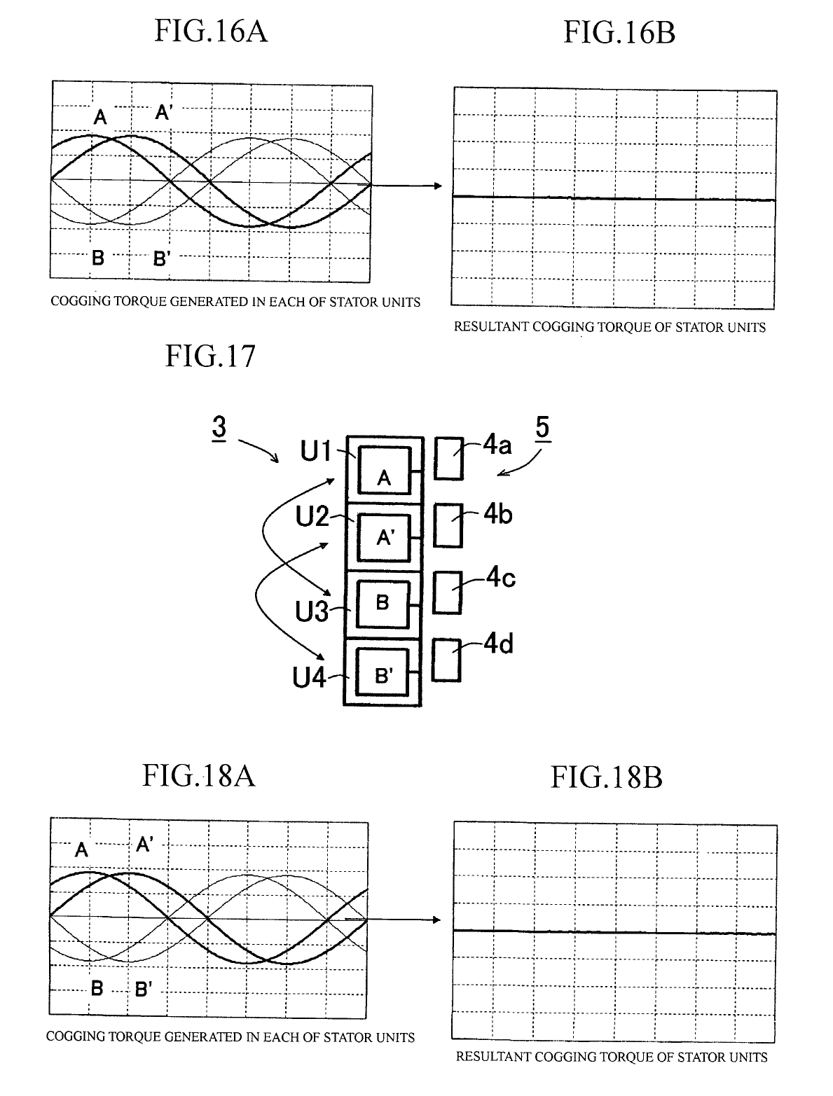

Cogging torque generated between the stator unit U1 of the A-phase and the first magnet 4a, cogging torque generated between the stator unit U3 of the B-phase and the third magnet 4c, cogging torque generated between the stator unit U2 of the A′-phase and the second magnet 4b and cogging torque generated between the stator unit U4 of the B′-phase and the fourth magnet 4d are shown in FIG. 16A. Resultant cogging torque of the cogging torque shown in FIG. 16A is shown in FIG. 16B. Since cogging torque is cancelled between the stator unit U1 of the A-phase and the stator unit U3 of the B-phase and between the stator unit U2 of the A′-phase and the stator unit U4 of the B′-phase, resultant cogging torque of the stator 3 can be reduced.

In FIG. 17, the rotor 5 is displaced in the axial direction. The rotor 5 is displaced, toward the stator unit U1 of the A-phase, from the state shown in FIG. 15. A facing area between the stator unit U1 of the A-phase and the first magnet 4a, a facing area between the stator unit U2 of the A′-phase and the second magnet 4b, a facing area between the stator unit U3 of the A′-phase and the third magnet 4c and a facing area between the stator unit U4 of the B′-phase and the fourth magnet 4d are not varied.

Cogging torque generated between the stator unit U1 of the A-phase and the first magnet 4a, cogging torque generated between the stator unit U2 of the A′-phase and the second magnet 4b, cogging torque generated between the stator unit U3 of the B-phase and the third magnet 4c and cogging torque generated between the stator unit U4 of the B′-phase and the fourth magnet 4d are shown in FIG. 18A. Resultant cogging torque of the cogging torque shown in FIG. 18A is shown in FIG. 18B. Since cogging torque generated in the stator unit U1 of the A-phase, the stator unit U2 of the A′-phase, the stator unit U3 of the B-phase and the stator unit U4 of the B′-phase are not varied. Therefore, cogging torque is cancelled as well as the example shown in FIGS. 16A and 16B, so that resultant cogging torque of the stator 3 can be reduced.

### COMPARATIVE EXAMPLE 3

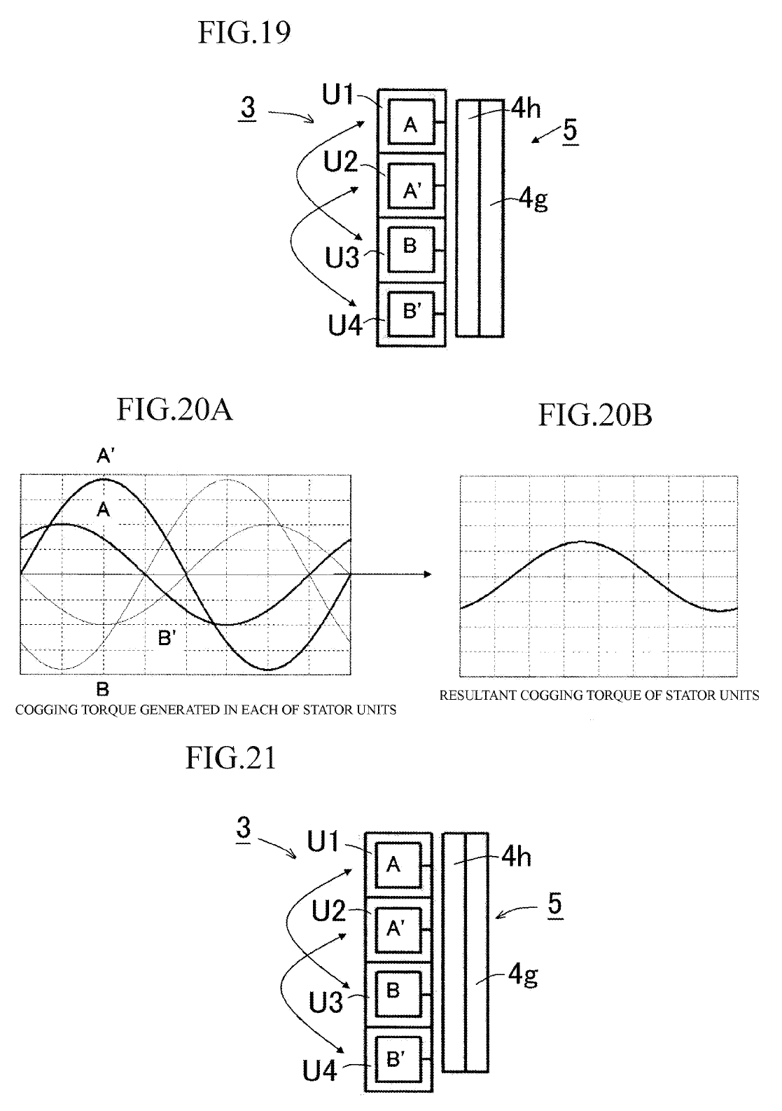

Next, a comparative example to the first and second embodiments will be explained with reference to FIGS. 19-22B. Note that, the structural elements explained in the second embodiment are assigned the same numeric symbols and explanation will be omitted. In FIG. 19, the stacking structure of the stator 3 is the same as that of the second embodiment, so explanation will be omitted. The rotor 5 is constituted by the shaft 6 and a single permanent magnet 4h, which is attached to the shaft 6 by a back yoke 4g. The permanent magnet 4h faces the claw poles of the stator unit U1 of the A-phase, the stator unit U2 of the A′-phase, the stator unit U3 of the B-phase and the stator unit U4 of the B′-phase. In case that a length of the motor is fixed, axial facing areas of both end parts of the permanent magnet 4h, which face the stator unit U1 of the A-phase and the stator unit U4 of the B′-phase, are made small so as to allow rotation of the rotor 5.

Cogging torque generated between the stator unit U1 of the A-phase, the stator unit U2 of the A′-phase, the stator unit U3 of the B-phase, the stator unit U4 of the B′-phase and the permanent magnet 4h are shown in FIG. 20A. Axial facing areas of the stator unit U1 of the A-phase and the stator unit U4 of the B′-phase are smaller than those of the stator unit U2 of the A′-phase and the stator unit U3 of the B-phase, so cogging torque cannot be cancelled between the A-phase and the B-phase and between the A′-phase and the B′-phase. Resultant cogging torque of the cogging torque shown in FIG. 20A is shown in FIG. 20B. Since cogging torque cannot be cancelled between the stator unit U1 of the A-phase and the stator unit U3 of the B-phase and between the stator unit U2 of the A′-phase and the stator unit U4 of the B′-phase, so each cogging torque is left and resultant cogging torque of the stator 3 is generated.

In FIG. 21, the rotor 5 is displaced in the axial direction. The rotor 5 is displaced, toward the stator unit U1 of the A-phase, from the state shown in FIG. 19. Facing areas between the stator unit U2 of the A′-phase, the stator unit U3 of the B-phase and the permanent magnet 4h are not varied. However, a facing area between the stator unit U1 of the A-phase and the permanent magnet 4h is increased; a facing area between the stator unit U4 of the B′-phase and the permanent magnet 4h is reduced.

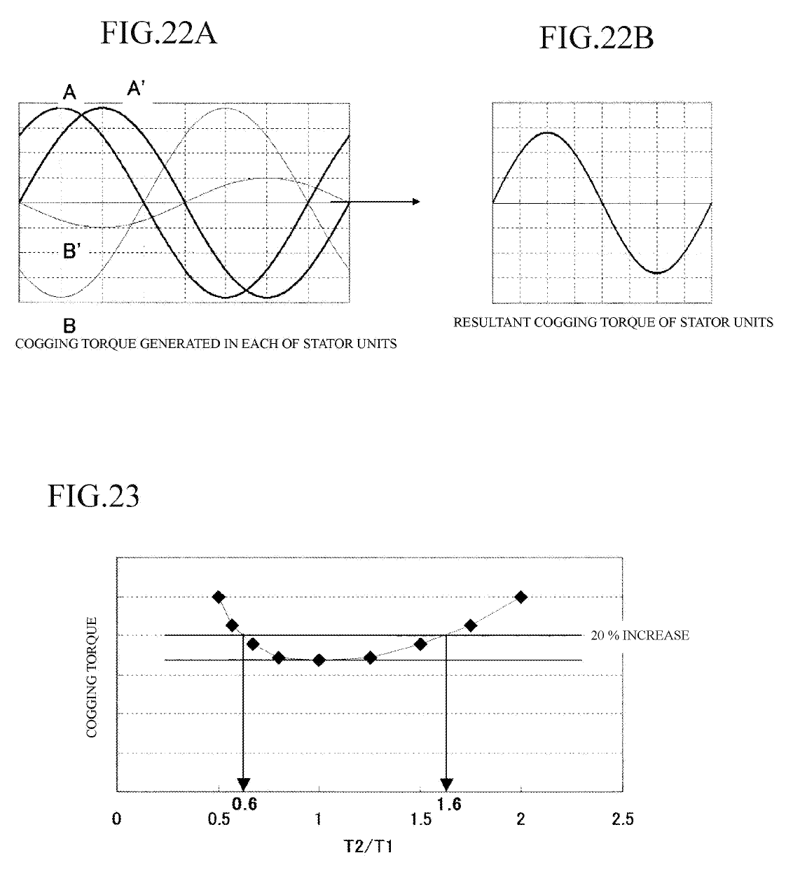

Cogging torque generated between the stator unit U1 of the A-phase, the stator unit U2 of the A′-phase, the stator unit U3 of the B-phase, the stator unit U4 of the B′-phase and the permanent magnet 4h are shown in FIG. 22A. Resultant cogging torque of the cogging torque shown in FIG. 22A is shown in FIG. 22B. Since cogging torque cannot be cancelled between the stator unit U2 of the A′-phase and the stator unit U4 of the B′-phase, so cogging torque is left and resultant cogging torque of the stator 3 is generated.

In the above described first and second embodiments, even if the axial position of the rotor 5 is displaced, amount of increasing or reducing facing areas of the permanent magnets facing the magnetic pole teeth of the stator are not varied in the axial direction due to a gap or gaps in the permanent magnet 4, so that unbalance of amount of magnetic flux can be small and cogging torque can be reduced.

Further, precompression springs, etc. can be omitted, so production cost of the rotary machine can be reduced.

In comparison with the second embodiment in which the rotor 5 has the four magnets 4a-4d, number of parts of the first embodiment, in which the rotor 5 has the two magnets 4a and 4b, can be reduced, so that assembling cost can be reduced, influence caused by accuracy of assembling the rotor to the stator or size tolerance can be reduced and cost of parts can be reduced.

Further, in case that the lengths of the gaps between the magnets of the second embodiment are equal, characteristics of the motor of the first embodiment can be improved, by extending the length of the permanent magnet 4, more than those of the second embodiment.

In the above described embodiments, the stepping motors are inner rotor type motors, but the present invention can be applied to outer rotor type motors, too.

In each of the above described embodiments, the stator 3 is driven by two-phase excitation drive system, and excitation cycle of the B-phase is shifted ¼ cycle with respect to that of the A-phase. However, the present invention is not limited to the two-phase excitation drive system, so four-phase excitation drive system, for example, may be employed. In case of the four-phase excitation drive system, four phases, whose excitation cycles are mutually shifted ⅛ cycle, are formed, but two phase groups, each of which includes two different phases, are excited with shifting ¼ cycle. Therefore, the four-phase excitation drive system can be used as well as the first and second embodiments.

In case that the stator units are stacked in a state where at least three boundary surface sections, in each of which claw poles are directly stacked, are formed and at least a pair of boundary surface sections, in each of which centers of the claw poles, in the rotational direction of the rotor, directly stacked are shifted an electric angle of 90°±30°, exist, cogging torque, which is generated by a magnetic circuit passing through the boundary surface section in which the claw poles facing the permanent magnet are directly stacked, can be further reduced.

In comparison with a full step drive system in which the rotor is turned one step angle by inputting one pulse, a micro step drive system, which improves resolution capability of the rotation of the rotor and restrains vibration, is capable of improving vibration damping property as a synergy effect.

The two-phase stepping motors have been explained as the embodiments, the present invention is not limited to the two-phase stepping motors. By employing the present invention, various types of permanent magnet type rotary machines, e.g., four-phase or six-phase stepping motor in which an axial length is extended but vibration can be reduced, can be realized or provided.

In the above described embodiments, a plurality of the magnets 4a-4d have the same shape and are composed of the same material, but they may have different shapes and may be composed of different materials as far as amounts of magnetic flux are same.

Further, the stator unit of the A-phase is provided to the one end of the stack of the stator units, but the stator unit of the B-phase may be provided to the one end of the stack. In this case, even if the stacking order of the A-phase and the B-phase or the A′-phase and the B′-phase is changed, the same effects can be obtained.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention has been described in detail, it should be understood that the various changes, substitutions, and alternations could be made hereto without departing from the spirit and scope of the invention.

What is claimed is:

1. A permanent magnet type rotary machine, which is driven by Q-phase (Q is an even number of two or more) excitation drive system,
comprising:
a multiple-phase excitation stator including a plurality of stacked stator units, in each of which air-core coils are sandwiched between stator yokes and magnetic pole teeth of the stator yokes are mutually geared, all of the stator units having the same number of magnetic pole teeth which are spaced, in the rotational direction of a rotor, at regular intervals, the stator units in the same phase being divided into n (n is an integer of one or more and the product of n and Q is an integer of four or more) for one phase and coaxially stacked; and
the rotor including a plurality of permanent magnets, which are arranged in the axial direction and whose magnetic poles face the magnetic pole teeth of the stator yokes,
wherein at least the stator unit of the first phase out of the two stator units, which are stacked with a phase difference of (360°/(2P)) (P is number of the magnetic poles of the permanent magnet), is stacked m-th (m is an integer of (nQ/2) or less, and one or more), from one end of the stack of the stator units, to face the magnetic poles of one the permanent magnets, and
the other stator unit of the second phase, whose excitation cycle is shifted ¼ cycle with respect to that of the stator unit of the first phase, is stacked ((nQ/2)+m)-th, from the one end of the stack, to face the magnetic poles of another permanent magnet.

2. The permanent magnet type rotary machine according to claim 1,
wherein the permanent magnets are a first magnet and a second magnet, which are arranged in an axial direction of a shaft,
the first magnet faces the magnetic pole teeth of the stator units which are the first to (nQ/2)-th stator units from the one end of the stack, and
the second magnet faces the magnetic pole teeth of the stator units which are the ((nQ/2)+1)-th to nQ-th stator units from the one end of the stack.

3. The permanent magnet type rotary machine according to claim 2,
wherein relationship between a distance T1, which is an axial distance from a plane perpendicular to the axis of the one end of the stack to the first magnet, and a distance T2, which is an axial distance from an intermediate plane perpendicular to the axis of the stack to the second magnet, is 0.6<T2/T1<1.6.

4. The permanent magnet type rotary machine according to claim 1,
wherein the permanent magnets are a first magnet, a second magnet, a third magnet and a fourth magnet, which are arranged in an axial direction of a shaft,
the first and second magnets face the magnetic pole teeth of the stator units which are the first to (nQ/2)-th stator units from the one end of the stack, and
the third and fourth magnets face the magnetic pole teeth of the stator units which are the ((nQ/2)+1)-th to nQ-th stator units from the one end of the stack.

5. The permanent magnet type rotary machine according to claim 4,
wherein relationship between a distance T1, which is an axial distance from a plane perpendicular to the axis of the one end of the stack to the first magnet, a distance T2, which is an axial distance from the plane perpendicular to the axis of the one end of the stack to the second magnet, a distance T3, which is an axial distance from an intermediate plane perpendicular to the axis of the stack to the third magnet, and a distance T4, which is an axial distance from the intermediate plane perpendicular to the axis of the stack to the fourth magnet, is 0.6<T3/T1<1.6 and 0.6<T4/T2<1.6.
